(19) United States
(12) Patent Application Publication
(10) Pub. No.: US 2008/0236089 A1
(43) Pub. Date: Oct. 2, 2008

(54) Frame, Particularly for a Door, Window, or Facade Element

(76) Inventor: Josef Westermann, Steinfeld (DE)

Correspondence Address: GUDRUN E. HUCKETT DRAUDT, SCHUBERTSTR. 15A, WUPPERTAL, 42289, DE

(21) Appl. No.: 11/576,694

(22) PCT Filed: Oct. 6, 2005
(86) PCT No.: PCT/EP05/10770

§ 371 Date: Jan. 4, 2008

(30) Foreign Application Priority Data
Oct. 9, 2004 (DE) 10 2004 049 336.7

(51) Int. Cl. E06B 1/28

(52) U.S. Cl. 52/653.2

(57) ABSTRACT

A frame for doors, windows, or facade elements has a profiled frame section to be arranged in a wall opening, wherein the profiled frame section has at least one basic profiled frame section. The profiled frame section has a multifunctional chamber extending substantially across at least one side of the frame. At least one part of the multifunctional chamber is part of the basic profiled frame section. A venting system having a moveable venting element is arranged at least partially within the multifunctional chamber. The venting element forms an air passage.

The invention relates to a frame for door elements, window elements, façade elements or the like, comprising a profiled frame section arranged in a wall opening, which profiled frame section comprises at least one basic profiled frame section.

It is an object of the invention to improve prior art frames and to design them in particular such that they are usable in different configurational variants.

The object is solved by a frame of the aforementioned kind that has in its profiled frame section a multifunctional chamber. The dimensions of the frame according to the invention is not greater due to the area of the multifunctional chamber and the frame can be offered, based on the different application possibilities of the multifunctional chamber, in a plurality of design variations.

A frame having a multifunctional chamber is to be understood in this context as a frame in which an area of the frame is configured for various application purposes.

Advantageously, the multifunctional chamber extends at least across substantially one side of the wall opening in order to optimally utilize the available space in the profiled frame section. Preferably, the multifunctional chamber extends across all sides of the profiled frame section, for example, in a conventional window across all four sides of the wall opening, so that the entire window frame can be designed variably, as needed.

In an especially advantageous configuration of the frame according to the invention it is provided that the multifunctional chamber is configured as a part of the basic profiled frame section already when producing the basic parts of the frame. In this way, the multifunctional chamber is arranged at a central location of the frame and can develop its effect, for example, to the exterior side as well as the interior side of the room, depending on its utilization. For reinforcing the basic profiled frame section, it can be additionally provided with at least one insert of glass-fiber reinforced plastic or similar reinforcing materials which insert is located for example in an edge area of the multifunctional chamber at a central location of the basic profiled frame section.

Advantageously, the multi-functional chamber is arranged in a part of the frame that is configured as the window frame. However, it is within the gist of the invention to arrange the multifunctional chamber in a part of the frame that is configured as a wing frame.

In one configurational variant of the multifunctional chamber in accordance with another advantageous embodiment of the invention, the chamber becomes part of a venting system that comprises a venting element configured as a rotatable venting tube in the multifunctional chamber that is then preferably round. The venting tube forms as a result of its shape at least one air passage in the multifunctional chamber which air passage serves as a venting connection between the interior side and the exterior side. The main axis of this venting tube extends parallel to the longitudinal extension of the profiled frame section and can thus extend across the large lateral parts of the frame. At least on two sides of the multifunctional chamber additional air supply or air exhaust areas are provided that are connectable for venting by the variable angle positions of the venting tube that serves for connecting or separating the two areas.

Advantageously, the venting tube is divided into at least one or two venting tube chambers wherein by rotation of the venting tube at least one venting tube chamber provides a venting connection between the air supply and air exhaust areas that are located on the different sides of the multifunctional chamber and correlated with the interior side or exterior side of the frame. As a result of the plurality of possible arrangements of the air supply or air exhaust areas, as well as based on the possibility of dividing the venting tube into one, two or three venting tube chambers, the frame according to the invention is useful for a plurality of different venting conditions. For example, it is possible to provide a pollen filter in the air passage formed by the venting tube. In this way, at high pollen levels in the air persons with allergies have the advantage of a pollen-free room air without having to forgo venting.

It is particularly advantageous to delimit an air supply or air exhaust area relative to the interior and/or exterior side of the room by means of at least one perforated and/or slotted or otherwise partially open auxiliary profiled section. In this way, the different attachment profiled sections or auxiliary profiled sections to be attached to the basic profiled frame section that is in particular formed as a basic hollow profiled section are used for providing the air supply or air exhaust area. Depending on the type of openings of the auxiliary profiled section, it serves e.g. to prevent small animals from accessing the air venting system of the frame. Moreover, by means of the different profiled sections provided for attachment to the profiled frame section that is preferably configured as a hollow profiled section the visual appearance of the frame is improved. Also, these auxiliary profiled sections can be provided with a filter material in order to filter pollen from the air.

It is moreover within the gist of the invention to design the venting tube or the venting element to be adjustable by means of a motor. This motor rotates or moves the venting tube/venting element into the desired position, based on control pulses of a control device or of optionally programmable and/or remote-controlled control electronics. In this connection, the motor is advantageously arranged above or below the venting element in the multifunctional chamber. Outside of the window frame there is therefore no additional space required for this comfortable control of the venting action and the entire venting system can be inserted into the frame already before mounting the frame. In the configurational variant with venting tube, the motor is preferably a mini tubular motor arranged in the multifunctional chamber.

Instead of utilizing a part of the multifunctional chamber for a venting system, according to another embodiment of the invention it is proposed to provide the multifunctional chamber at least partially with parts of an insect protection device. However, the latter can be arranged in addition to the venting device on another side of the window frame so that the different embodiments of the multifunctional chamber supplement one another within one frame.

The parts of the multifunctional chamber that are not occupied by a venting system or an insect protection system can still be filled with insulation material for improving the insulation of the window frame, which insulation material can also be exchangeable as a result of the possibility of opening the multifunctional chamber later, i.e., after having been mounted in the window frame.

A door, a window, a façade element or the like equipped with the frame according to the invention can be variably configured and therefore significantly distinguishes itself from the prior art.

Further advantages and details of the invention result from the schematic illustrations of the invention described in the following. The drawings show in:

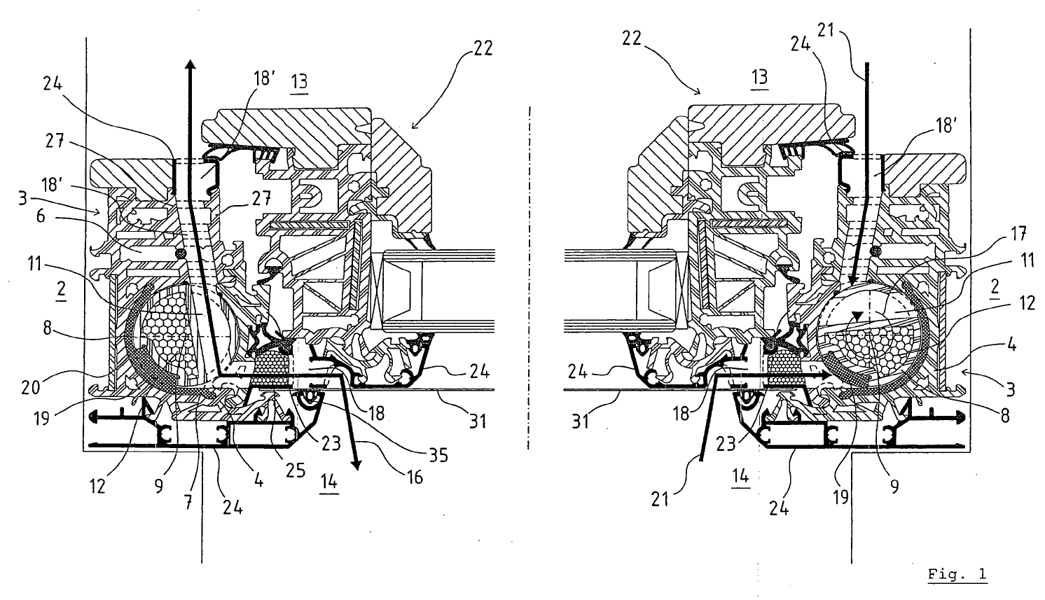

FIG. 1 an embodiment of a window frame with a correlated wing frame in a horizontal section wherein the venting system is open at the left side and closed at the right side;

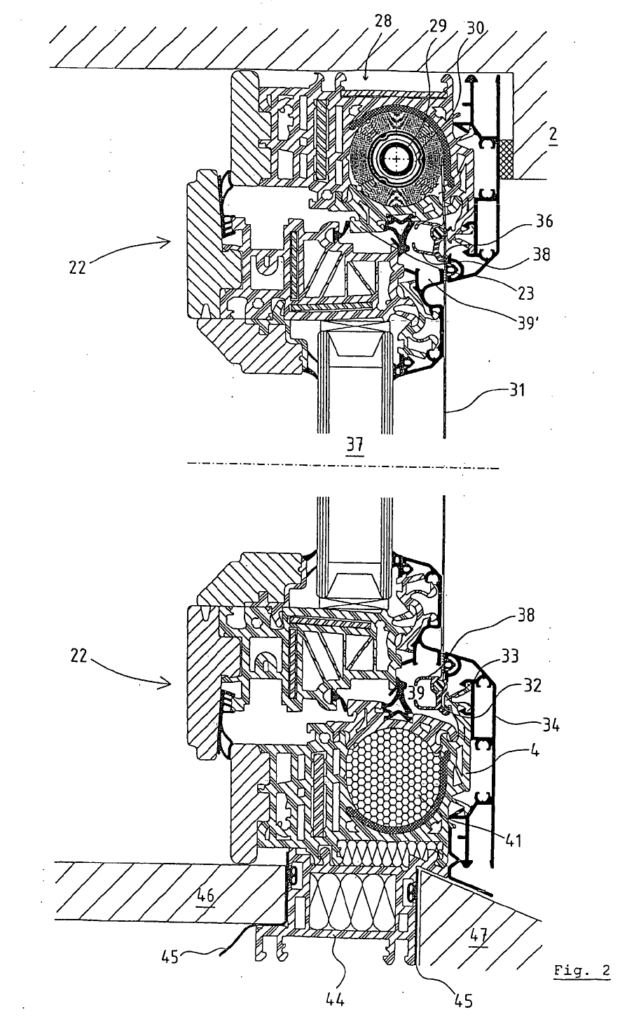

FIG. 2 the object of FIG. 1 in a vertical section;

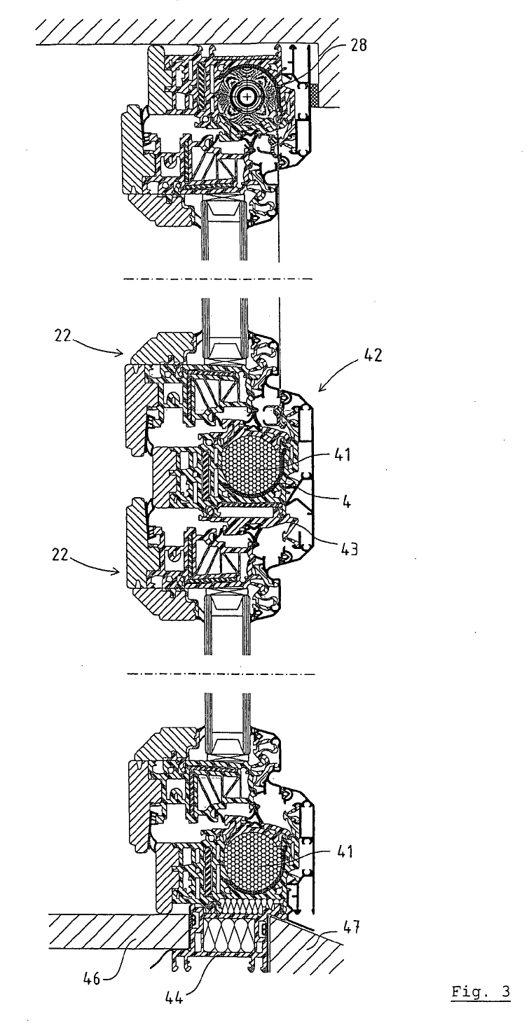

FIG. 3 a further embodiment of a window frame according to the invention with correlated wing frame in a vertical section;

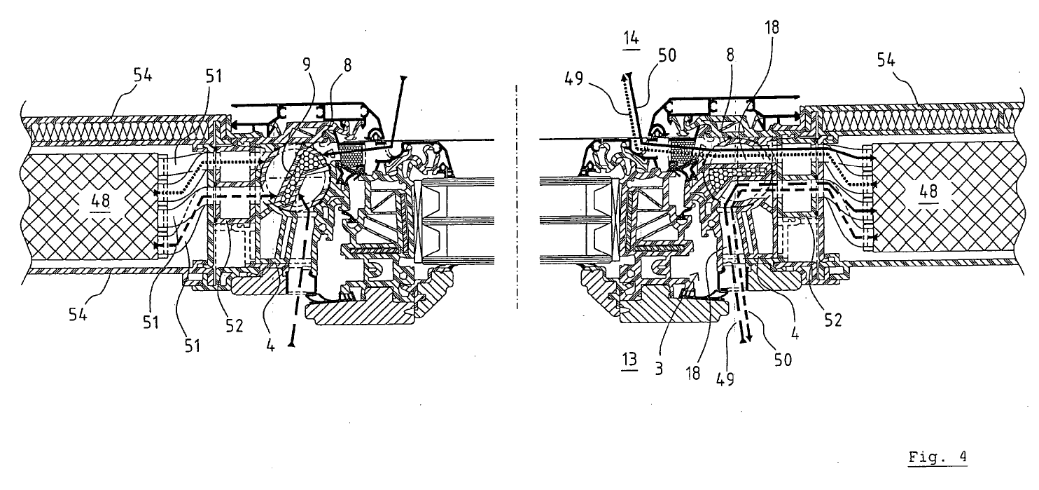

FIG. 4 a partial section of a window frame according to the invention with a venting system provided with a heat exchanger.

A frame according to the invention, here a window frame 1 that is arranged in a wall 2, is essentially formed of a profiled frame section configured as a hollow profiled section 3. The hollow profiled section 3, in turn, comprises a basic profiled frame section configured as a basic hollow profiled section 4 that delimits, in addition to several insulation cavities 6, at least partially a multifunctional chamber 7 provided for venting purposes. In this multifunctional chamber 7 there is a venting tube 8 that is rotatable about axis 9 which is its longitudinal axis. The venting tube 8 is divided essentially into two chambers 11 and 12 of which the chamber 11 can provide a connection of the interior side 13 of the room with the exterior side 14 of the room, as illustrated in the left part of FIG. 1. The black double arrows 16 symbolizes in this part of the Figure the connection between the interior side 13 and the exterior side 14.

In the right part of FIG. 1, the venting tube is rotated relative to the venting tube in the left part of FIG. 1, as indicated by the arrow 17. Instead of a rotation in the mathematical negative sense it is also possible to rotate in the mathematical positive sense. By rotation of the venting tube 8 an air supply or air exhaust area 18 facing the exterior side 14 is closed off relative to an air supply or air exhaust area 18′ facing the interior side 13 by means of a seal that is embodied in this embodiment as a hollow chamber seal 19 and arranged on the outer side of the venting tube chamber 12. In this way, venting is interrupted and the interior and exterior sides 13 or 14 or the air supply or air exhaust areas 18, 18′ are separated from one another; this is indicated by the two arrows 21.

Advantageously, the multifunctional chamber 7 in cross-section is essentially rounded as can be seen in FIG. 1, wherein the hollow profiled section 3 is reinforced by means of at least one insert 20 made from glass-fiber reinforced plastic. When using a venting tube 8 that is also round there are significant space savings relative in comparison to other shape combinations. However, it is also conceivable to provide the multifunctional chamber 7 to be, for example, square in cross-section or to be embodied in a different shape and to use therein also a preferably round venting tube 8, wherein then the remaining areas of the multifunctional chamber 7 could also be filled with insulation material in order to further improve the insulating values of the window frame 1 according to the invention.

The basic hollow profiled section 4 of the window frame according to the invention in this embodiment is configured as a platform profiled section onto which in multiple ways different additional profiled sections can be attached. For the variable configuration of the attachment possibilities on a wing frame 22 as well as for the variable configurations of the window frame 1 itself, open areas of the multifunctional chamber 7 can be closed off partially with different profiled sections or attachment profiled sections. The profiled strip 23 or attachment profiled section 23 illustrated in FIG. 1 serves for at least partially closing the multifunctional chamber 7 and the arrangement of a wing frame 22 in the closed position of the window frame 1 and wing frame 22. As a result of the already mentioned configuration of the basic hollow profiled section 4 as a platform profiled section, it is also within the gist of the invention to configure (also) the air supply or air exhaust areas 18, 18′ arranged on at least two sides of the multifunctional chamber 7 by means of attachment of one or several auxiliary profiled sections 24. The use of these auxiliary profiled sections 24 leads to a further improved adaptability of the window frame 1 according to the invention to e.g. different façade appearances.

The embodiment illustrated to the left in FIG. 1 provides air supply from the exterior side 14 by means of the preferably perforated auxiliary profiled section 24, arranged on the wing frame 22 and embodied as a glass securing strip, into the exterior opening area 18 of the cavity 7 that is provided with a pollen filter 25 and farther through appropriate longitudinal slots of the profiled strip 23, also referred to as window frame closure strip, into the cavity 7. Moreover, the venting passage extends through the open venting tube 8 and again through the basic hollow profiled section 4, open by means of longitudinal slots, as well as on the interior side by means of an auxiliary profiled section 24 that is clamped into projecting adapter stays 27 and embodied, for example, as a perforated U-shaped profiled section made from aluminum and forming the closure of the opening area 18′ relative to the room side.

The vertical section illustrated in FIG. 2 shows that in the upper and lower profiled sections of the window frame according to the invention that is provided laterally with a venting system the multifunctional chamber allows the use of an insect roller screen 28 which is part of an insect protection device. This insect roller screen 28 is arranged in the upper basic hollow profiled section 4 of the window frame 1 according to the invention and has in addition to a shaft 29 an integrated tensioning device 30 embodied as a coil spring or spiral spring as well as an insect screen 31 wound onto the shaft 29. The shaft 29 with integrated spiral spring is supported in the end areas of the shaft in bearing shells. These bearing shells are covered after the profiled strip 23 has been mounted. In addition, the profiled strip 23 is shortened for the passage of the insect screen 31, for example, a synthetic gauze screen, in regard to width. It is understood that despite of the configuration as an insect protection device the insect screen can also be replaced by a pollen protection screen for filtering pollen from the air or by a shade screen for shading the room.

The insect screen 31 is guided by means of two aluminum profiled clamping sections 24 (FIG. 1) of the wing frame and of the window frame and in the lower area of FIG. 2 is hooked by means of a hook strip 32 that is arranged at the extendable end of the insect screen 31 in a part 33 of the basic hollow profiled section 4 and is additionally guided by the outer cover 34. Such guides are also provided in a configuration of the window with a center post wherein the insect screen 31 in this case can also be divided into two parts, or is provided within the moving wing of a double-wing window without center post. Accordingly, in the multifunctional chamber 7 in the upper frame of the window two insect screens can be provided. In the retracted position of the insect screen 31, the hook is in a complementary position on the basic hollow profiled section 4 provided with the insect screen 28, as illustrated at numeral 36 in dashed lines, wherein there are no parts of the insect protection device visible from the interior or the exterior that would disturb the overall impression of the frame. The insect roller screen 28 prevents thus effectively insects from entering through the wall opening 37 even in the case of an open wing frame 22. For improved manipulation of the insect roller screen 28 the hook strip 36 or 32 is provided with a securing stay 38 that, even in the case of the window being closed, fits into the unneeded sealing cavity 39 or 39′. In the area of the insect screen the window frame is sealed by means of a brush seal 35.

Advantageously, the multifunctional chamber is provided in the lower part of the basic hollow profiled section 4 with insulation material 41 which further improves the insulation properties of the window frame 1 that is already well insulated because of its multi-chamber cavity system.

The embodiment illustrated in FIG. 3 is particularly suitable for use in tilting skylight windows. The frame according to the invention has in this vertical section three areas with multifunctional chambers of which the two lower areas are filled with insulation material 41 while the upper area is provided with an insect roller screen 28. The insect protection device of the upper half of FIG. 3 with the insect roller screen and the holders of the insect screen correspond to those of the insect protection device of FIG. 2.

It is also within the gist of the invention to move the insect screen or the shading screen or pollen protection screen comfortably by means of a preferably remote-control motor that can be arranged also in the multifunctional chamber.

It is also conceivable to arrange the insect roller screen 28 outside of the window frame structure, for example, in a rabbet plane, wherein the inventive window frame 1 together with the wing must be constructively match to this configuration. It is also conceivable to construct the window frame 1 in such a way that a profiled area that has not yet been used before is provided with the possibility of arranging therein an additional roller shade so that, for example, an insect screen 31 and a shade can be positioned parallel to one another. The window frame 1 according to the invention including the wing would require for this purpose only a somewhat different size and would be provided, for example, in its lateral areas with venting systems or venting tubes 8 as well as preferably insect protection or shade screens (as well as possibly additionally a pollen screen) moveable from the upper frame part to the lower frame part.

The basic hollow profiled section 4 of the central area of FIG. 3 is configured with the aid of different auxiliary profiled sections as a locking member 42. In particular, the arrangement of a profiled section 43 leads to a stop for the wing frames 22 identically configured above and below the central basic hollow profiled section 4. The window frame 1 of FIG. 2 as well as the window frame of FIG. 3 are connected to an interior window sill 46 and an exterior window sill 47 by means of a profiled section 44 for adjoining windowsills, which profiled section is filled with insulation material and has at both ends a groove for a film 45.

As a further possible variant, the hollow profiled section provided with a multifunctional chamber 7 provides connecting possibilities for a heat exchanger 48 (FIG. 4). In this connection, a heat exchanger profiled section 54 containing the heat exchanger 48 is connected to the basic hollow profiled section 4. For this configuration, the basic hollow profiled section 4 can also be slightly changed with regard to its prior cross-sectional shapes, for example, can be designed to be disassembled into its individual parts in order to be able to service the heat exchanger 48 in the mounted state by removing the inwardly positioned parts of the window frame 1 without complete removal of the frame.

Since the heat exchanger profiled section 54 optionally extends into the wall 2, this wall must have appropriate cutouts. Preferably, the heat exchanger is supplied with air by means of the multifunctional chamber 7 or by means of the venting tube 8 arranged in the multifunctional chamber 7, wherein the venting tube 8 not only is divided into two chambers but also has four separate chambers extending along the longitudinal axis of the venting tube 8 for a total of four connectors of the heat exchanger. Conceivable are also further chambers, depending on whether the heat exchanger is designed to control the air flow additionally to venting or e.g. control air flow alone. FIG. 4 show schematically the air passages in the area of the multifunctional chamber wherein the arrow lines 49 represent the air that passes from the room interior through the heat exchanger 48 to the exterior while the lines 50 represent the air that flows from the room exterior through the heat exchanger into the interior. The air connectors 51 are connected by means of the adapter profiled section 52 with the chambers arranged in the longitudinal direction of the longitudinal axis 9 of the venting tube 8.

What is claimed is:

1.-24. (canceled)

25. A frame for doors, windows, or facade elements, the frame comprising:
a profiled frame section adapted to be arranged in a wall opening, wherein the profiled frame section comprises at least one basic profiled frame section;
wherein the profiled frame section has a multifunctional chamber.

26. The frame according to claim 25, wherein the multifunctional chamber extends substantially across at least one side of the frame.

27. The frame according to claim 25, wherein at least one part of the multifunctional chamber is part of the basic profiled frame section.

28. The frame according to claim 25, further comprising several differently designed attachment profiled sections for configuring the profiled frame section as desired, wherein the multifunctional chamber is partially open and covered by one of the attachment profiled sections.

29. The frame according to claim 25, further comprising a venting system having a moveable venting element arranged at least partially within the multifunctional chamber, wherein the venting element forms at least one air passage, wherein a main axis of the venting element extends parallel to a longitudinal extension of the profiled frame section, wherein air supply and air exhaust areas are present at least on two sides of the multifunctional chamber.

30. The frame according to claim 29, wherein the venting element has at least one venting element chamber that creates by movement of the venting element a venting connection between the air supply and air exhaust areas.

31. The frame according to claim 29, wherein the air supply and air exhaust areas are formed by attaching an auxiliary profiled section to the profiled frame section.

32. The frame according to claim 25, wherein the venting system comprises a motor and is provided with a control device that controls movement of the venting tube by the motor.

33. The frame according to claim 32, wherein the motor is arranged in the multifunctional chamber.

34. The frame according to claim 29, wherein the movable venting element is configured as a rotatable venting tube.

35. The frame according to claim 29, wherein the movable venting element is configured as a slidable venting chamber profiled section within the multifunctional chamber.

36. The frame according to claim 25, wherein the multifunctional chamber is at least partially part of an insect protection device.

37. The frame according to claim 36, wherein the insect protection device is an extendable insect roller screen with an integrated tensioning device wherein the insect roller screen is arranged in the multifunctional chamber.

38. The frame according to claim 37, wherein the insect roller screen has a shaft provided with a pretensioned spiral spring, wherein the shaft is supported in bearing shells arranged at the ends of the shaft.

39. The frame according to claim 37, wherein an extendable end of an insect screen of the insect roller screen has a fastening area that is attachable to a side of the frame positioned opposite the insect roller screen.

40. The frame according to claim 39, wherein the insect screen is guided laterally on a guiding profiled section arranged on the profiled frame section.

41. The frame according to claim 37, wherein the insect protection device or at least a part thereof is removable from the frame for cleaning purposes, wherein at least one detachable auxiliary profiled section is provided for securing and/or making accessible the insect protection device.

42. The frame according to claim 25, wherein the multifunctional chamber is filled partially with an insulation material.

43. The frame according to claim 25, further comprising a heat exchanger connected for venting by the multifunctional chamber to the interior side and exterior side of a room.

44. The frame according to claim 25, wherein the basic profiled frame section is a basic hollow profiled section.

45. The frame according to claim 25, wherein the profiled frame section is configured as a hollow profiled section.

46. A door having a frame according to claim 25.

47. A window having a frame according to 25.
